(19) United States
(12) Patent Application Publication
(10) Pub. No.: US 2012/0095899 A1
(43) Pub. Date: Apr. 19, 2012

(54) Community-based metropolitan funds

(76) Inventor: Adam Matthew Black, Cincinnati, OH (US)

(21) Appl. No.: 13/317,322

(22) Filed: Oct. 15, 2011

Related U.S. Application Data
(60) Provisional application No. 61/455,148, filed on Oct. 15, 2010.

(51) Int. Cl. G06Q 40/04

(52) U.S. Cl. 705/37

(57) ABSTRACT

A community-based metropolitan fund is a collection of investment instruments which focus solely on performance of publicly traded companies with community ties to a metropolitan area. The community ties for each managed fund for each respective metropolitan area are either (1) that the publicly traded company has headquarters in said metropolitan area, (2) that the publicly traded company has its principal place of business within the metropolitan area, (3) that the publicly traded company has more employees engaged within the metropolitan area than any other metropolitan area, or (4) that the publicly traded company has a higher payroll within the metropolitan area than any other metropolitan area. The managed fund is either an open-end fund, an exchange traded fund, or a closed end fund, and is a broad-based mutual fund with investments in many types of securities to reduce risk of loss in the event of a downturn.

This application is related to and claims priority to U.S. Provisional Application No. 61/455,148, Entitled “Metropolitan and Regional Funds,” filed on Oct. 15, 2010.

### FIELD OF USE

This invention relates generally to the field of financial investment systems, and more specifically, to investment funds and index of funds in which managed funds are available to investors which are investment instruments (open-end funds, exchange traded funds, and closed end funds) that focus solely on the performance of publicly-traded companies that are located within a major metropolitan area.

### BACKGROUND OF THE INVENTION

There are about eight thousand professionally-managed mutual funds in the United States, and the number is increasing each year. Many smaller investors know little about the funds purchased by their financial advisors. In a bear market, many investors become dissatisfied with their mutual fund holdings and have no idea what makes some funds better than others, since even the most highly-regarded equity funds may lose value dramatically. In recent years, more and more investors are taking an increased interest in their personal investments and seek to invest in funds where they have some emotional connection.

Some relevant prior art includes the following:
U.S. Pat. No. 7,680,725 (Bloom et al.) discloses a financial product based on a first fund that is traded and registered on a trading marketplace in a first country. The first fund has the characteristics of being based on an index of securities that are traded in a second, different country. The first fund is arbitragable with a second fund that is based on the index and which is registered in a second different country. The first fund has a creation unit basis that is substantially the same basis as a creation unit basis for the second fund. The calculation of the net asset value of the first fund occurs at essentially the same time that second country fund has its Net Asset Value calculated.

U.S. Patent Document No. 20080306881 (Feldman) discloses a method and system for creating an investment vehicle associated with a geographic region. The method comprises forming a set of securities based on inclusion criteria, and categorizing the securities according to geographic region, where the geographic region of a security may be determined based at least in part on the presence of a headquarters location of the issuing company in the geographic region.

U.S. Patent Document No. 20070198389 (Orloske et al.) discloses an inventive index that includes securities from one or more select companies headquartered in at least two geographic or political localities within a select geographic region. For example, the index can include the ten largest publicly traded corporations by market capitalization within each of the fifty states of the U.S.

U.S. Patent Document No. 20070033128 (McNair) discloses a health information network fund in which a portion of the assessed investment fund fees or investment fund service providers' fees or capital gains are designated for underwriting a health information network such as a National Health Information Network Organization or Regional Health Information Organization as directed by the investment fund's manager and general partner. Shareholders of one or more open-ended fund share classes and closed-ended unit investment trust share classes designate one or more National Health Information Network Organization or Regional Health Information Organization to receive the accumulated amounts attributable to their individual accounts.

U.S. Patent Document No. 20040249735 (Cassani et al.) discloses an investment fund in which a portion of the assessed investment fund fees or investment fund service providers' fees are designated for donation to charitable causes as directed by each of the investment fund's shareholders. Shareholders of one or more charitable share classes designate one or more charities to receive the accumulated donation amounts attributable to their individual accounts. Donation amounts are then tracked and paid to charities on a periodic basis according to the designations on the records of the investment fund.

Many investors in Middle America have strong commitments to their own and other local communities and their economies, while becoming increasingly disenchanted with the activities of Wall Street.

Also, many smaller investors are becoming dissatisfied with their mutual fund holdings. They have no idea what makes one fund better than another, since even the most highly regarded equity funds have fallen dramatically and the investors have little understanding of what any of the individual holdings are within their own retirement portfolios.

While some municipal bond funds currently focus on core holdings within any one given state (for tax-exempt purposes), the concept of community-based equity funds is currently being ignored by Wall Street, which may be the root cause of the current disconnect between Middle America and Wall Street.

Thus, there is a need to enable individual investors to reconnect with their investment portfolios away from Wall Street and back to local communities that are meaningful to them.

### SUMMARY OF THE INVENTION

A “managed fund” is a broad-based mutual fund with investments in several types of securities to reduce risk of loss in the event of a downturn. Investment managers actively buy and sell investments and try to increase the fund's value by more than the general increase in the value of the markets that they invest in. The fund is invested in a diverse range of securities so as to keep risk to a minimum.

In the preferred embodiment of the present invention, the community ties for each managed fund for each respective metropolitan area are either (1) that the publicly traded company has headquarters in said metropolitan area, (2) that the publicly traded company has its principal place of business within the metropolitan area, (3) that the publicly traded company has more employees engaged within the metropolitan area than any other metropolitan area, or (4) that the publicly traded company has a higher payroll within the metropolitan area than any other metropolitan area. Other secondary community ties may be (5) that the publicly traded company has its U.S. headquarters located in the metropolitan area, (6) that the publicly traded company has corporate research and development facilities within the metropolitan area, (7) that the publicly traded company has more U.S. employees in the metropolitan area than any other U.S. metropolitan area, (8) that the publicly traded company has a major division headquarters located in the metropolitan area.

The biggest advantage of the community-based metropolitan funds of the present invention is clearly providing investors with additional choices on where to invest their money. The more choices individual investors have, the more tailored their selections can be and the more open our markets will become. Individual investors will welcome the community-based metropolitan funds of the present invention in Middle America with the connection they need to make Wall Street feel like it is a little closer to home. As opposed to investing in companies on the other side of the planet, individual investors will have an opportunity to invest in companies located within one metropolitan area with strong ties to their local communities. Instead of exposing investors to the uncertainties of overseas markets, investors will be provided with diversified investments within their own and neighboring communities.

The preferred embodiment of the definition of a “metropolitan area” for purposes of this Patent/Application is a city as a first preferred embodiment of the metropolitan area of the present invention. A “city” is a relatively large and permanent settlement. A “city” generally has complex systems for sanitation, utilities, land usage, housing, and transportation. The concentration of development greatly facilitates interaction between people and businesses, benefiting both parties in the process. A “county” in the U.S. is an administrative division of the state in which the boundaries are drawn. In the U.S., in states where counties presently exist, a county is a second preferred embodiment of the metropolitan area of the present invention. In the U.S. a metropolitan statistical area (MSA) is a geographical region with a relatively high population density at its core and close economic ties throughout the area. Such regions are not legally incorporated as a city or town would be. The MSA does not have legal administrative divisions like counties or sovereign entities like states. As such the precise definition of any given metropolitan area can vary with the source. A typical MSA is centered around a single large city that wields substantial influence over the region (e.g. Chicago). However, some MSAs contain more than one large city with no single municipality holding a dominant position (e.g. Minneapolis-Saint Paul). MSAs are defined by the U.S. Office of Management and Budget (OMB) only. In the U.S., an MSA is a third preferred embodiment of the metropolitan area of the present invention.

The community-based metropolitan funds of the present invention will provide investors with a sense of familiarity to the holdings within their portfolio. The community-based metropolitan funds of the present invention will enable investors to own companies located right in their own communities, that they can read about in their local newspaper, which may employ their friends, neighbors and family, while also providing these investors with a more reasonable risk management strategy by diversifying their investment among a basket of companies, as opposed to one or two individual equities.

For a more complete understanding of the community-based metropolitan funds of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1A is a simplified schematic of a first preferred embodiment of a community-based index of metropolitan funds of the present invention, providing the investor with current financial and demographical data for buying and selling community based metropolitan funds for the 30 largest cities in the U.S.

FIG. 1B is a simplified schematic of a second preferred embodiment of a community-based index of metropolitan funds of the present invention, providing the investor with current financial and demographical data for buying and selling community based metropolitan funds for the 30 largest counties in the United States.

FIG. 1C is a simplified schematic of a third preferred embodiment of a community-based index of metropolitan funds of the present invention, providing the investor with current financial and demographical data for buying and selling community based metropolitan funds for the 30 largest Metropolitan Statistical Areas (MSAs) in the U.S.

FIG. 2A is a simplified schematic of a fourth preferred embodiment of a community-based index of metropolitan funds of the present invention, providing the investor with current financial and demographical data for buying and selling community based metropolitan funds for the 25 largest cities proper in the world.

FIG. 2B is a simplified schematic of a fifth preferred embodiment of a community-based index of metropolitan funds of the present invention, providing the investor with current financial and demographical data for buying and selling community based metropolitan funds for the 10 most prominent international financial centers (cities) in the world.

FIG. 2C is a simplified schematic of a sixth preferred embodiment of a community-based index of metropolitan funds of the present invention, providing the investor with current financial and demographical data for buying and selling community based metropolitan funds for the 10 most economically powerful cities in the world.

FIG. 3A an example of a Houston Growth & Income Fund using the principles of the community-based metropolitan funds of the present invention, wherein all of the companies are headquartered in the city of Houston, Tex., Harris County.

FIG. 3B an example of a Chicago Growth & Income Fund using the principles of the community-based metropolitan funds of the present invention, wherein all of the companies are headquartered in the Metropolitan Statistical Area of Chicago, Ill.

FIG. 4A discloses a 1^{st} hypothetical configuration of a community-based metropolitan fund of the present invention under a 1^{st} set of market conditions.

FIG. 4B discloses a 2^{nd} hypothetical configuration of the same community-based metropolitan fund of the present invention after the fund manager has made some adjustments to the community-based metropolitan fund based on current and projected market conditions trying to increase the value of said managed fund by more than a general increase in value of markets.

FIG. 5 discloses a simplified logic diagram for a preferred embodiment for conducting a transaction involving either buying or selling an open-end fund, an exchange traded fund, or a closed end fund for the community-based metropolitan fund of the present invention.

FIG. 6 discloses a simplified logic diagram for a preferred embodiment for building a community-based metropolitan fund according to the present invention.

### DETAILED DESCRIPTION OF THE PREFERRED EMBODIMENTS

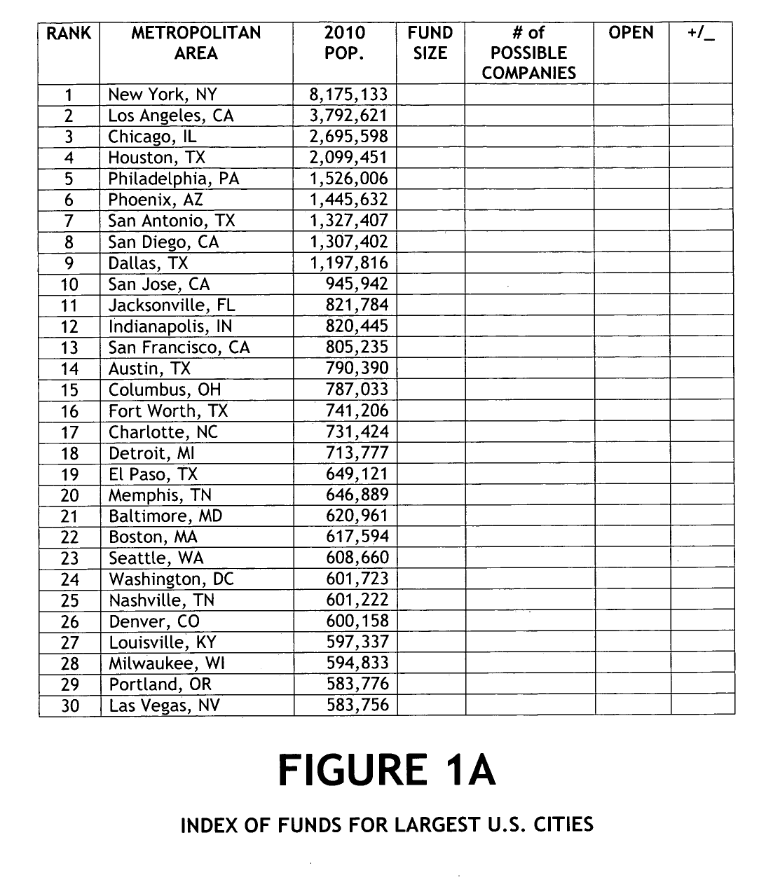

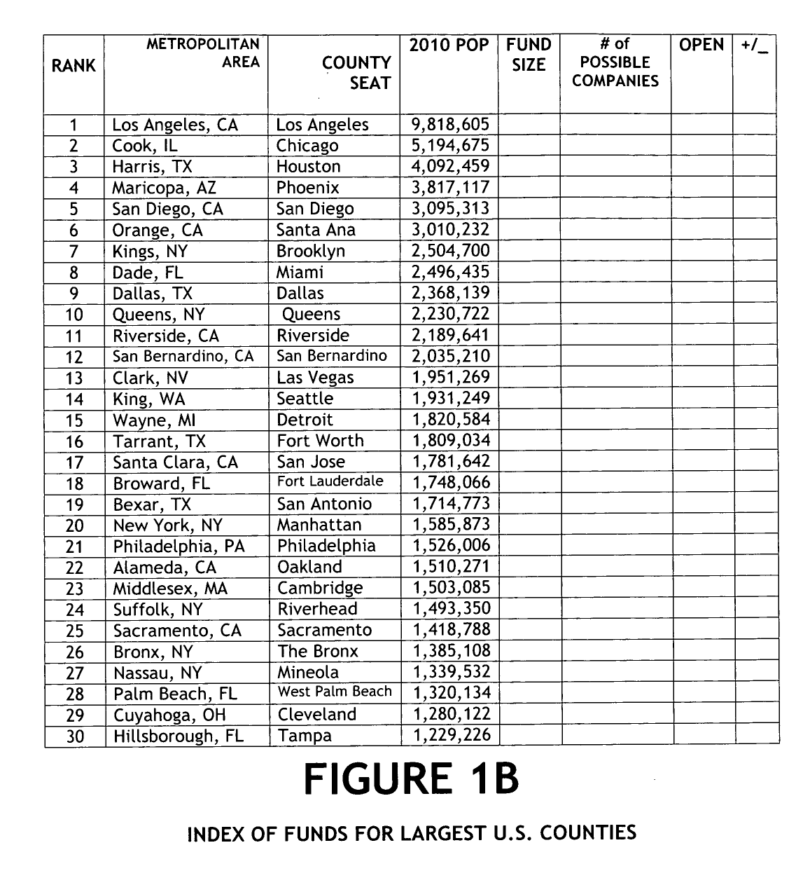

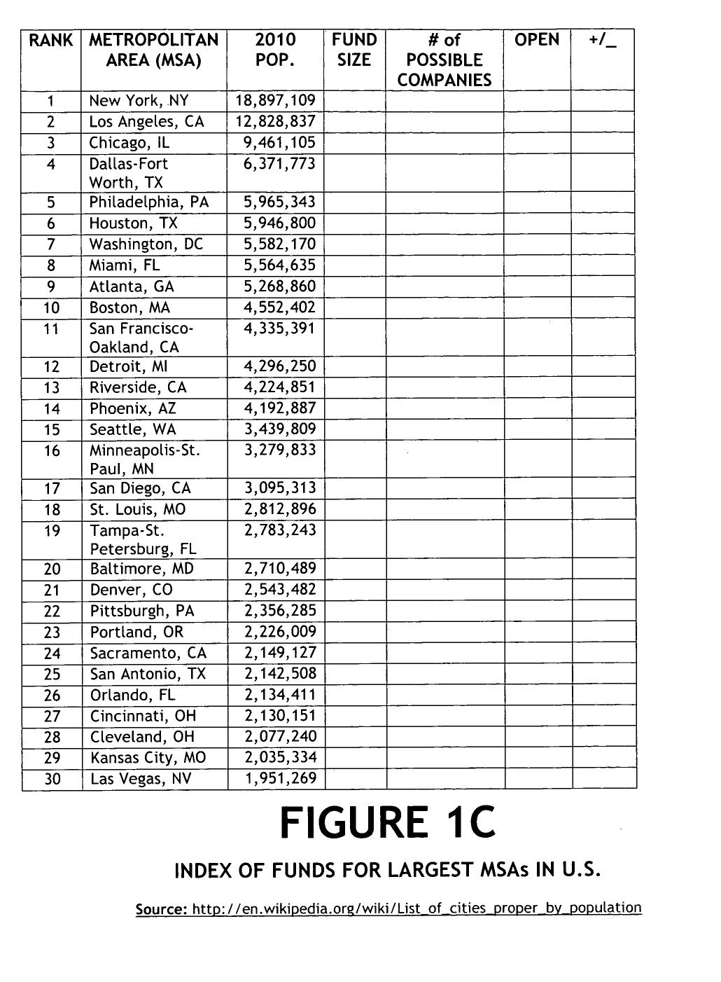

Referring now to the drawings, FIG. 1A is a simplified schematic of a first preferred embodiment of a community-based index of metropolitan funds of the present invention, providing the investor with current financial and demographical data for buying and selling community based metropolitan funds for the 30 largest cities in the United States. Similarly, FIG. 1B is a simplified schematic of a second preferred embodiment of a community-based index of metropolitan funds of the present invention, providing the investor with current financial and demographical data for buying and selling community based metropolitan funds for the 30 largest counties in the United States; and FIG. 1C is a simplified schematic of a third preferred embodiment of a community-based index of metropolitan funds of the present invention, providing the investor with current financial and demographical data for buying and selling community based metropolitan funds for the 30 largest Metropolitan Statistical Areas (MSAs) in the United States. The population datum listed in FIGS. 1A, 1B, and 1C are from the 2010 census.

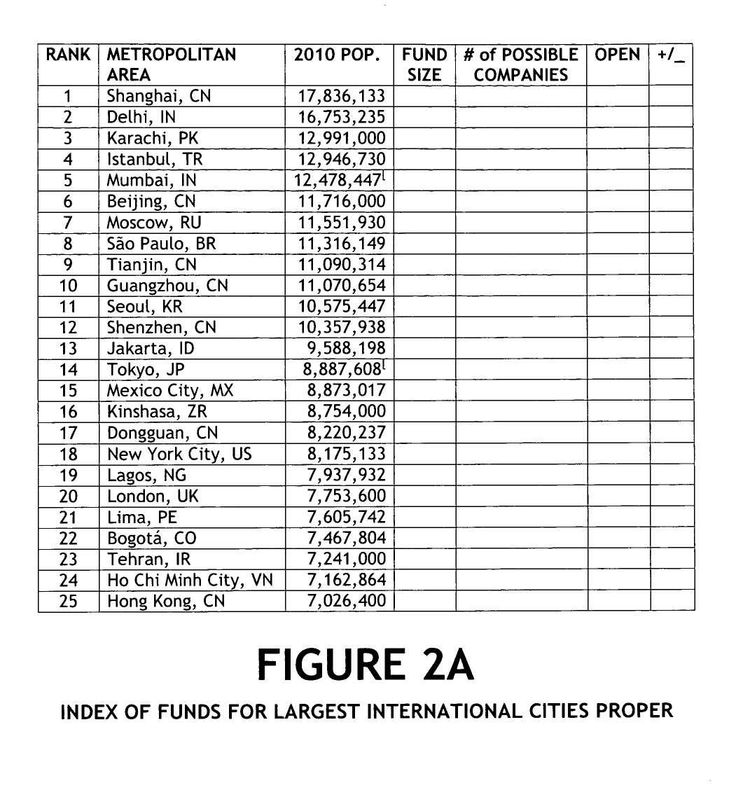

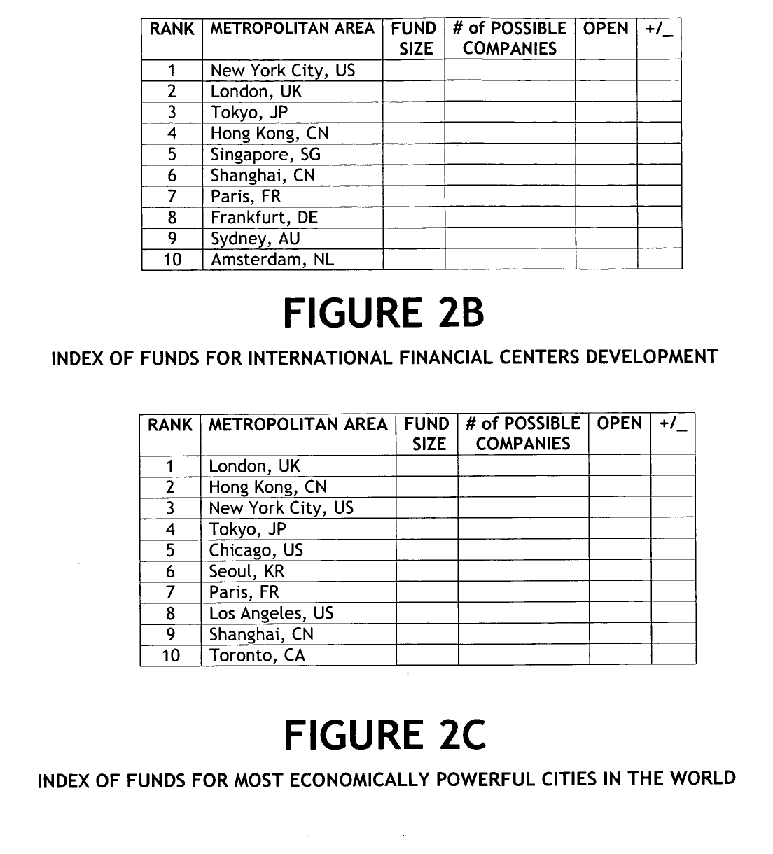

Internationally, FIG. 2A is a simplified schematic of a fourth preferred embodiment of a community-based index of metropolitan funds of the present invention, providing the investor with current financial and demographical data for buying and selling community based metropolitan funds for the 25 largest cities proper in the world. FIG. 2B is a simplified schematic of a fifth preferred embodiment of a community-based index of metropolitan funds of the present invention, providing the investor with current financial and demographical data for buying and selling community based metropolitan funds for the 10 most prominent international financial centers, or cities, in the world. This ranking of cities was selected by the American Chicago Mercantile Exchange and Dow Jones & Company partnering with China's Xinhua News Agency released the Xinhua-Dow Jones International Financial Centers Development Index in 2011. FIG. 2C is a simplified schematic of a sixth preferred embodiment of a community-based index of metropolitan funds of the present invention, providing the investor with current financial and demographical data for buying and selling community based metropolitan funds for the 10 most economically powerful cities in the world. This ranking of cities was made by Forbes in 2008.

The community-based metropolitan index of funds comprises tabulation data of a plurality of community-based metropolitan funds. Each community-based metropolitan fund is a collection of investment instruments that focus on performance of publicly traded companies with community ties to a specific metropolitan area selected by the investor.

In a perfect world, the community ties for the community-based metropolitan funds of the present invention would be the corporate headquarters of the publicly traded companies. However, in recent years publicly traded companies have moved their corporate headquarters to states, provinces, and countries that offer them the best tax advantages and the companies maintain only a token presence. Accordingly, the definition of community ties for the community-based metropolitan funds of the present invention must be broadened to include the metropolitan area where the corporation's high-level officers direct, control, and coordinate the corporation's activities (see Hertz v. Friend, 130 S.Ct. 1181 (2010)). Other primary community ties for the community-based metropolitan funds of the present invention are either the metropolitan area where the publicly traded company has more employees than any other metropolitan area, or the metropolitan area where the publicly traded company a higher payroll within the metropolitan area than any other metropolitan area.

Some secondary considerations that may be used for determining community ties for the community-based metropolitan funds of the present invention are (1) that the publicly traded company has its U.S. headquarters located in the metropolitan area, (2) that the publicly traded company has corporate research and development facilities within the metropolitan area, (3) that the publicly traded company has more U.S. employees in the metropolitan area than any other U.S. metropolitan area, (4) that the publicly traded company has a major division headquarters located in the metropolitan area. Other secondary considerations for community ties for the community-based metropolitan funds of the present invention are the particular metropolitan area where the majority of employees, production activities, sources of income, and sales are found.

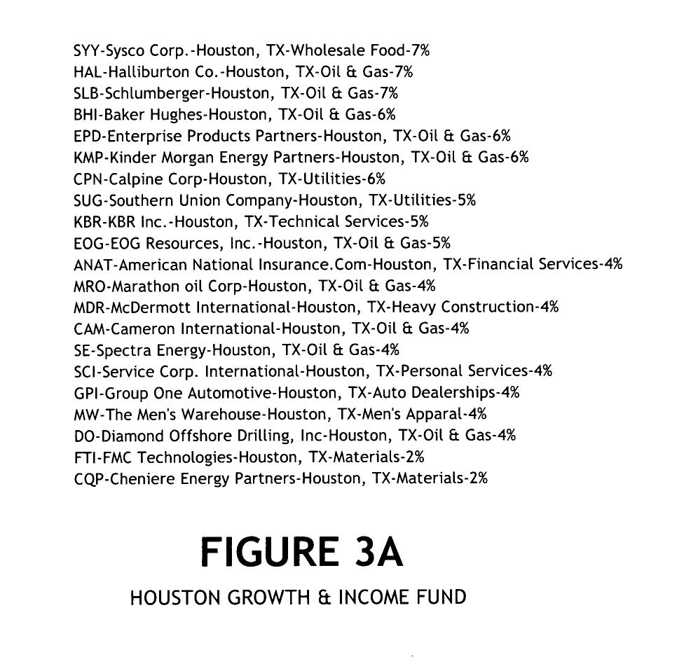

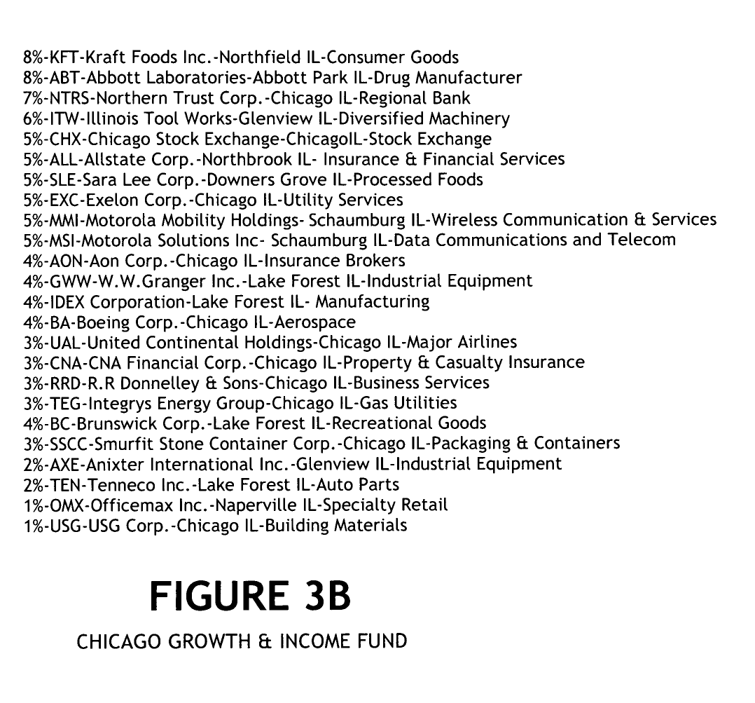

FIG. 3A an example of a Houston Growth & Income Fund using the principles of the community-based metropolitan funds of the present invention. All of these companies have their headquarters in the city of Houston, Tex., Harris County. In the case of an open end fund, these securities would be professionally managed by one or more fund managers who oversee equity selection and allocation. Larger companies like Halliburton and Schlumberger, would have a larger weighting than smaller companies like Cheniere in the preferred embodiment. This should reduce volatility and help manage risk. Sample weightings for the equities within the fund are listed on a percentage basis. In another embodiment, all companies have the same or similar weightings.

FIG. 3B an example of a Chicago Growth & Income Fund using the principles of the community-based metropolitan funds of the present invention. All of these companies have their headquarters in the Metropolitan Statistical Area of Chicago, Ill.

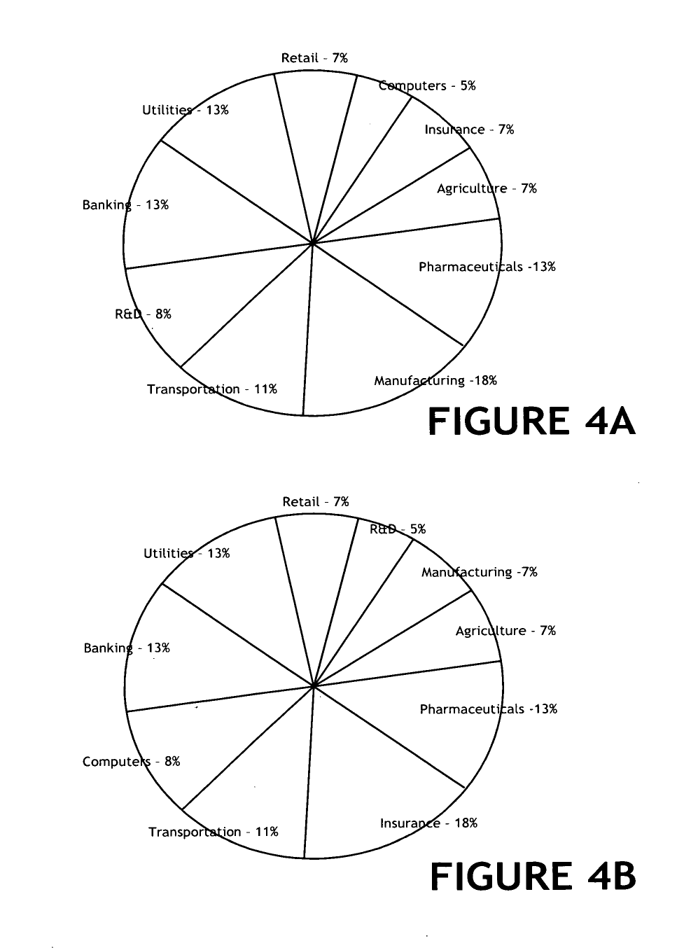

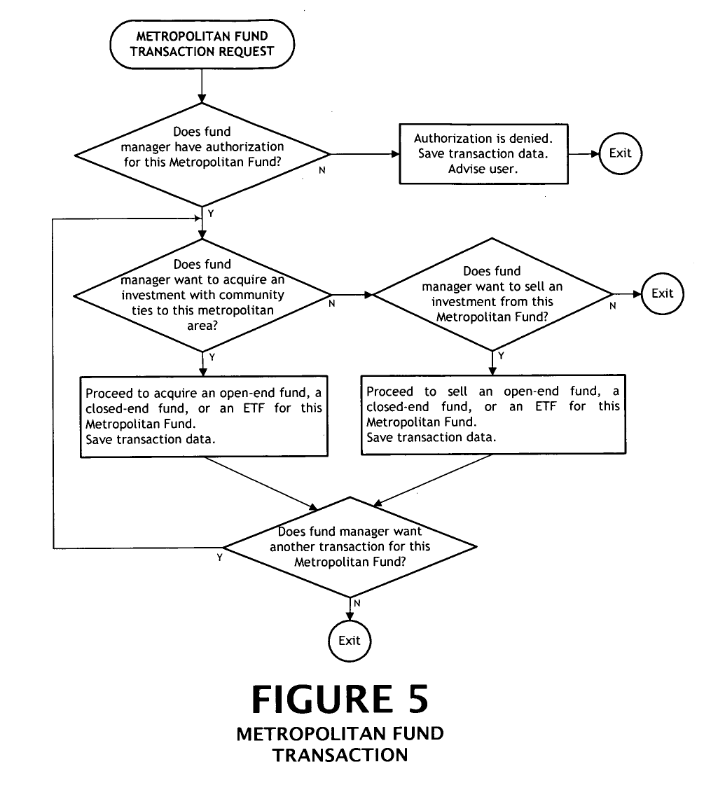

FIG. 4A discloses a 1^{st} hypothetical configuration of a community-based metropolitan fund of the present invention under a 1^{st} set of market conditions.

FIG. 4B discloses a 2^{nd} hypothetical configuration of the same community-based metropolitan fund of the present invention after the fund manager has made some adjustments to the community-based metropolitan fund based on current and projected market conditions trying to increase the value of said managed fund by more than a general increase in value of markets. In this hypothetical, the fund manager is anticipating a downturn in the market for industrials (manufacturing and R&D), has sold off some of these holdings for the community-based metropolitan fund and acquired other holdings involving computers and insurance for the metropolitan fund having community ties to the metropolitan area.

The community-based metropolitan fund is a managed fund. The managed fund is either an open-end fund, an exchange traded fund, or a closed end fund. The managed fund is a broad-based mutual fund with investments in a plurality of types of securities to reduce the risk of loss in the event of a market downturn. At least one investment manager actively buys and sells investments and trying to increase value of the managed fund by more than a general increase in value of the markets.

Of course, the financial advisor selling the product will need to be compensated for placing a client into a suitable investment that meets the needs of the client. Annual expense ratios are tied to the cost of transactions and compliance. Fund managers will be talented local money managers from the geographical area within the metropolitan area. These funds will have active management, which will include equity selection, equity allocation, and rebalancing. The compensation of these managers is also included in the sales charges and expense ratios listed below. Typical fees and expenses are set out below:
Mutual Fund A Shares-5.5% front-end load (sales charge); 0.75% expense ratio (annually).
Mutual Fund B Shares-0 front end load (sales charge); 1.0% expense ratio (annually); 5.5% back-end sales charge (upon sale of fund, pro-rated over time).
Mutual Fund C Shares-0 front end load (sales charge); 1.95% expense ratio (annually); 1% back-end sales charge (upon sale of fund).

The community-based metropolitan funds of the present invention comprise approximately 15 to 40 individual equities of companies headquartered within the same metropolitan area, the number of individual equities depending upon the size of the metropolitan area. Once packaged this group of equities would be sold as an individual security in the form of either an open-end fund (mutual fund), exchange traded fund, or closed end fund.

There are two types of mutual funds—“open-end funds” and “closed-end funds”. Both of these funds sell shares to investors and use the money invested to buy securities that match their investment missions. But that's where the similarities end.

When people say “mutual funds” they are usually referring to “open-end funds”. “Open-end funds” can sell an unlimited number of shares to investors. The price per share—also known as the net asset value—is calculated by dividing the market value of the fund's assets by the number of shares held by investors. If a fund has net assets of $100 million and there are 5 million fund shares owned by investors, the fund's share price would be $20. That's why open-end mutual funds trade only at the end of each day, when trading stops and the final price can be calculated. Most people own the open-end variety in their retirement and taxable accounts.

“Closed-end funds” issue a set number of shares at the fund's origin that trade on the stock exchange throughout the day. The value of these shares is based on demand. If many investors buy shares, the price goes up. If investors dump them, the price goes down. If an investment is made in a “closed-end fund” with a share price that is lower than its net asset value, a discount is obtained. If the gap between that fund's share price and its net asset value narrows after the investment, the investor receives a bonus when the shares are sold. Most “closed-end funds” offer a discount. The key is knowing how much of a discount is being offered and whether the fund will perform well over time. If it does, the discount shrinks, and a profit can be earned. Like “open-end funds”, “closed-end funds” come in many types ranging from U.S. stock and bond funds. “Closed-end funds” tend to be actively managed—meaning the fund manager buys and sells securities in an effort to outperform the fund's benchmark index, such as the Dow Jones Industrial Average.

An “exchange traded fund” is a fund that tracks an index, but can be traded like a stock. “exchange traded funds” always bundle together the securities that are in an index; they never track actively managed mutual fund portfolios (because most actively managed funds only disclose their holdings a few times a year, so the “exchange traded fund” would not know when to adjust its holdings most of the time). Investors can do just about anything with an “exchange traded fund” that they can do with a normal stock, such as short selling. Because “exchange traded funds” are traded on stock exchanges, they can be bought and sold at any time during the day (unlike most mutual funds). Their price will fluctuate from moment to moment, just like any other stock's price, and an investor will need a broker in order to purchase them, which means that the investor will have to pay a commission. On the plus side, “exchange traded funds” are more tax-efficient than normal mutual funds. Since “exchange traded funds” track indexes they have very low operating and transaction costs associated with them. There are no sales loads or investment minimums required to purchase an “exchange traded fund”.

Over the last few years, outflows of equity mutual funds have been significant. This is the result of two primary factors:
1. There is no emotional connection between individual investors and the funds they own. Some funds have catchy names like the Fidelity Contrafund or the Growth Fund of America, but during periods of underperformance many average investors lack the patience to endure short-term losses in a fund they have trouble differentiating from the thousands of other funds on the market. This can lead to poor-decision making by the investors, who sell when the market is correcting due to a lack of familiarity with their investments, which in turn hurts the financial advisor, who is trying to manage both the client's portfolio and their expectations.
2. Investors often lack understanding of the funds. Some funds and “exchange traded funds” track an index, such as the S&P 500, but others have objectives that are vaguer. Many investors own several funds, which diversify them amongst large, mid, and small cap equities, as well as investments that focus on either growth or value, but in the end, what does all this mean? Investors understand that owning one or two individual equities and nothing else can make their portfolio extremely volatile. Mutual fund investing has removed some of the volatility, but investors also have trouble relating these funds to what they are actually trying to accomplish. The metropolitan funds of the present invention solve these problems and will increase mutual fund inflows substantially.

By providing investors with a vehicle that enables them to invest in a group of professionally managed stocks that are from a single metropolitan area, the focus of the investor is moved from Wall Street to the metropolitan area, which may be where the investor lives or has some other emotional connection. The investor will have an increased level of comfort and confidence in knowing that the investment fund includes companies that conduct business and employ individuals in and around the selected metropolitan area. The community-based metropolitan funds of the present invention are designed to compliment an investor's portfolio by emphasizing investment in local companies. This type of fund is a superb core holding for an endowment. For example, the University of Chicago could invest a portion of their endowment in the aforementioned Chicago Public Opportunities Fund, which would provide them with a solid portfolio of equities and also give them the peace of mind in knowing their goals are aligned with the success of local companies. Similarly, local treasurers can invest funds entrusted to them back in the local communities that they serve. These funds will also be very popular in 529 plans. The community-based metropolitan funds of the present invention are an excellent tool to plan for a child's education by purchasing one of these funds and enabling the tax-free appreciation of local equities to help off-set the rising costs of tuition.

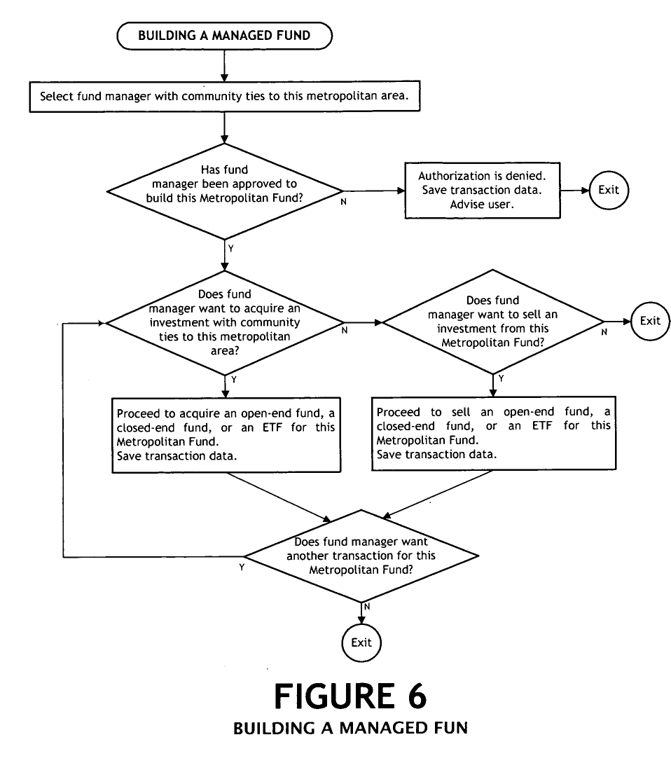

FIG. 6 discloses still yet another preferred embodiment for assembling a managed community-based metropolitan fund. Initially, a publicly-traded company is selected having community ties to a metropolitan area. Next, discrete numbers of shares of the publicly-traded company are purchased by at least one investment manager of the managed fund. Additional publicly traded companies are selected and shares purchased until the metropolitan fund is fully assembled. The managed fund is an open-end fund, an exchange traded fund, or a closed end fund. The managed fund is a broad-based mutual fund with investments in a plurality of types of securities to reduce risk of loss in the event of a downturn. At least one investment manager actively buys and sells investments and tries to increase value of the managed fund by more than a general increase in value of markets where investments are made.

In yet another preferred embodiment of the community-based metropolitan funds of the present invention, a smaller investor manages the portfolio him or herself using the systems and methods described in U.S. Pat. No. 6,601,044 (Wallman). The Patent describes method and apparatus for enabling individual or smaller investors or others to create and manage a portfolio of securities or other assets or liabilities on a cost effective basis. An embodiment of the system includes a first processor interfaced with an investor's PC to select a plurality of assets to be in the investor's portfolio based on the investor's indicated preferences, to manage the portfolio in accordance with market changes and changes in the investor's indicated preferences, and to electronically place at least one asset trading order in accordance with the investor's indicated preferences.

Throughout this specification, there are various patent/applications that are referenced by application number and inventor. The disclosures of these patents/applications are hereby incorporated by reference in their entireties into this specification in order to more fully describe the state-of-the-art.

It is evident that many alternatives, modifications, and variations of the present invention and any others disclosed herein of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

I claim:

1. A community-based metropolitan index of funds comprising:
tabulation data of a plurality of metropolitan funds, each of said plurality of metropolitan funds being a collection of investment instruments which focus on performance of publicly traded companies with community ties to one metropolitan area, each of said plurality of metropolitan funds being a managed fund, each said managed fund being either an open-end fund, an exchange traded fund, or a closed end fund, each said managed fund being a broad-based mutual fund with investments in a plurality of types of securities to reduce risk of loss in the event of a market downturn, at least one fund manager for each said metropolitan fund actively buying and selling investments and to increase value of said managed fund by more than a general increase in value of markets;
whereby said publicly traded companies for each said metropolitan fund may thereafter be acquired independently or independently disposed of by said at least one fund manager for each said metropolitan fund.

2. The community-based metropolitan index of funds of claim 1, wherein said community ties for each said managed fund for each respective metropolitan area being either that said publicly traded company has headquarters in said metropolitan area, that said publicly traded company has its principal place of business within said metropolitan area, that said publicly traded company has more employees engaged within said metropolitan area than any other metropolitan area, or that said publicly traded company has a higher payroll within said metropolitan area than any other metropolitan area.

3. The community-based metropolitan index of funds of claim 1, wherein each said metropolitan area is a city.

4. The community-based metropolitan index of funds of claim 1, wherein each said metropolitan area is a U.S. county.

5. The community-based metropolitan index of funds of claim 1, wherein each said metropolitan area is a metropolitan statistical area (MSA) as defined by the U.S. Office of Management and Budget (OMB).

6. A method of trading from a community-based metropolitan fund, said community-based metropolitan fund being a managed fund, said managed fund having at least one fund manager, said method comprising:
selling holdings within said metropolitan area of said community-based metropolitan fund within a first segment of the market where said at least one fund manager anticipates a downturn;
replacing said holdings with new holdings within said metropolitan area of said community-based metropolitan fund within a second segment of said market that appear to be more stable to said at least one fund manager than said first segment;
whereby said managed fund is either an open-end fund, an exchange traded fund, or a closed end fund, said managed fund being a broad-based mutual fund with investments in a plurality of types of securities to reduce risk of loss in the event of a market downturn, said at least one investment manager actively buying and selling investments and trying to increase value of said managed fund by more than a general increase in value of the market.

7. The method of trading from a managed fund of claim 6, wherein a majority of said community ties to said metropolitan area are that said publicly traded company has headquarters in said metropolitan area, or has its principal place of business within said metropolitan area.

8. The method of trading from a managed fund of claim 6, wherein a majority of said community ties to said metropolitan area are that said publicly traded company has more employees engaged within the metropolitan area than any other metropolitan area.

9. The method of trading from a managed fund of claim 6, wherein a majority of said community ties to said metropolitan area are that said publicly traded company has a higher payroll within the metropolitan area than any other metropolitan area.

10. The method of trading from a managed fund of claim 6, wherein said metropolitan area is a city.

11. The method of trading from a managed fund of claim 6, wherein said metropolitan area is a U.S. county.

12. The method of trading from a managed fund of claim 6, wherein said metropolitan area is a metropolitan statistical area (MSA) as defined by the U.S. Office of Management and Budget (OMB).

13. A community-based metropolitan fund being a collection of investment instruments which focus solely on performance of publicly traded companies with community ties to a metropolitan area, said managed fund being either an open-end fund, an exchange traded fund, or a closed end fund, said managed fund being a broad-based mutual fund with investments in a plurality of types of securities to reduce risk of loss in the event of a market downturn, at least one investment manager actively buying and selling investments and trying to increase value of said managed fund by more than a general increase in value of the market.

14. The community-based metropolitan fund index of claim 13, wherein a majority of said community ties to said metropolitan area are that said publicly traded company has headquarters in said metropolitan area.

15. The community-based metropolitan fund index of claim 13, wherein a majority of said community ties to said metropolitan area are that said publicly traded company has its principal place of business within said metropolitan area.

16. The community-based metropolitan fund of claim 13, wherein a majority of said community ties to said metropolitan area are that said publicly traded company has more employees engaged within the metropolitan area than any other metropolitan area.

17. The community-based metropolitan fund of claim 13, wherein a majority of said community ties to said metropolitan area are that said publicly traded company has a higher payroll within the metropolitan area than any other metropolitan area.

18. The community-based metropolitan fund of claim 13, wherein said metropolitan area is a city.

19. The community-based metropolitan fund of claim 13, wherein said metropolitan area is a U.S. county.

20. The community-based metropolitan fund of claim 13, wherein said metropolitan area is a metropolitan statistical area (MSA) as defined by the U.S. Office of Management and Budget (OMB).
